(19) United States
(12) Patent Application Publication
(10) Pub. No.: US 2026/0309514 A1
(43) Pub. Date: Oct. 8, 2026

(54) METHOD FOR DETERMINING A ROTATIONAL ANGLE OUTPUT SIGNAL OF A POSITION SENSOR

(71) Applicant: Robert Bosch GmbH, Stuttgart (DE)

(72) Inventors: Michael Mueller, Holzgerlingen (DE); Benjamin Lechner, Pforzheim (DE); Christoph Schuster, Stuttgart (DE)

(21) Appl. No.: 19/481,568

(22) PCT Filed: Apr. 23, 2024
(86) PCT No.: PCT/EP2024/061069

§ 371 Date: Nov. 5, 2025

(30) Foreign Application Priority Data
May 11, 2023 (DE) 10 2023 204 375.0

(51) Int. Cl. G01D 3/02; G01B 7/30

(52) U.S. Cl. CPC G01D 3/022; G01B 7/30

(57) ABSTRACT

The invention relates to a method for determining a rotational angle output signal of a position sensor. In this method, a rotational angle position is measured as a measured angle signal (φ_{Mess}) as a function of time (S100), and the measured angle signal (φ_{Meas}) is corrected using a correction angle signal (φ_{Corr}) (S110) in order to obtain a filter input angle signal (φ_{FiltInp}). The correction input angle signal (φ_{CorrInp}) is output as the rotational angle output signal (S140). Furthermore, the filter input angle signal (φ_{FiltInp}) is filtered (S120) in order to obtain a correction input angle signal (φ_{CorrInp}), and the correction angle signal (Corr) is determined as a function of the correction input angle signal (φ_{CorrInp}), a frequency (f_{Meas}) of the filter input angle signal (φ_{FiltInp}) and an angle error signal (φ_{Error}) (S130), wherein the angle error signal (φ_{Error}) is determined by calculating a difference between the filter input angle signal (φ_{FiltInp}) and the correction input angle signal (φ_{CorrInp}). The determination (S130) the correction angle signal (φ_{Corr}) comprises determining (S131) a first coefficient and a second coefficient for a first and a second component of at least one harmonic of the angle error signal (φ_{Error}) and determining (S132) the correction angle signal (φ_{Corr}) as a function of the determined first and second coefficients, a first angular function of the first component, and a second angular function of the second component of the at least one harmonic using the frequency (f_{Meas}) of the filter input angle signal (φ_{FiltInp}).

### BACKGROUND

The present invention relates to a method for determining a rotational angle output signal of a position sensor as well as a computing unit and a computer program for carrying it out.

For determining a rotational angle, position sensors, such as inductive or based on a magnetoresistive effect, such as GMR (Giant MagnetoResistance) or TMR (Tunnel MagnetoResistance), can be used.

The rotational movement generates sine and cosine signals in the position sensor, which can be captured by an analog-digital converter (ADC).

An angle signal determined from these signals may have periodic errors, in particular vibrations. In particular, phase shifts, harmonics or upper harmonics on the sine and cosine signals and mechanical influences signals cannot always be corrected.

### SUMMARY

According to the invention, a method for determining a rotational angle output signal of a position sensor as well as a computing unit and a computer program for carrying it out are proposed with the features of the disclosure.

The invention reduces the harmonic error in the position angle signal of a position sensor that leads to significant rotational angle inaccuracies by determining and compensating for the harmonic vibrations. This allows the angular accuracy to be purposefully adjusted in order to achieve the required measurement accuracy, wherein the method is independent of the design, principle, or type of the position sensor.

In the method according to the invention for determining a rotational angle output signal of a position sensor, a rotational angle position is measured as a measured angle signal (raw signal) as a function of time, corrected with a correction angle signal in order to obtain a filter input angle signal. The filter input angle signal is passed through a filter, in particular a state variable filter, to determine a correction input angle signal, which is also output as the rotational angle output signal. For example, using the rotational angle output signal, an electric machine may be controlled. The filtering can in particular include low-pass filtering so that, as the frequency increases, the harmonic components in particular are filtered out.

The correction angle signal is then determined from the angle error, a frequency, in particular the base frequency, the filter input angle signal, and the correction input angle signal. The difference between the filter input angle signal and the correction input angle signal determines an angle error that includes substantially the filtered out components, and thus in particular the harmonic components.

To determine the correction angle signal, a first coefficient and a second coefficient are determined for a first and a second component of at least one harmonic of the angle error signal. The coefficients are in particular amplitude values for each of a first and a second component of at least one harmonic. The components may be represented by angular functions, in particular sine and cosine functions. Furthermore, a representation by means of real and imaginary components is also conceivable.

Subsequently, the correction angle signal is determined as a function of the specific first and second coefficients and the first angular functions of the first component and the second angular function of the second component of the at least one harmonic using the frequency of the filter input angle signal. The correction angle signal is in particular the sum of a product of the first coefficient with the angular function of the first component and a product of the second coefficient with the angular function of the second component. In particular, depending on the harmonic, a multiple of the frequency, in particular the base frequency, of the filter input angle signal multiplied by time is used as the angle of the angular function. The correction angle signal essentially contains the harmonic component and their phase position up to a certain or desired order, which are thus withdrawn from the raw signal.

The method can compensate for periodic angle errors, in particular angle errors generated by harmonics, thereby enabling the rotational angle to be determined more precisely.

For example, the invention may improve the control of electrical machines comprising a stator and a rotor. Thus, significant torque inaccuracies caused by the angle error, which cannot be compensated for with previous concepts, can be compensated for, thereby meeting torque accuracy requirements and thus allowing for efficient operation of an electric machine.

Furthermore, cost-efficient position sensors can achieve the required measurement accuracy by purposeful adjusting the angular accuracy, whereby the method can be cost-efficiently implemented.

In addition, the method is not dependent on the type or the measurement principle of the position sensor or the design of the electric machine with the position sensor, as the correction is performed on the angle. It can therefore be transferred to various, also older, types of position sensors, which can also achieve an improvement in torque accuracy in already existing systems or future new position sensor systems.

In one embodiment, to determine the first coefficient and the second coefficient for the first and the second components of the at least one harmonic of the angle error signal, the product of the correction input angle signal and the angular function of the first and second components of the at least one harmonic, respectively, is integrated over a predetermined time period using the frequency of the filter input angle signal. The predetermined time period can in particular be the sampling period of the position sensor. The coefficients can be precisely determined by the time integration of the specified product, which allows the angle error to be compensated for particularly precisely and thereby the aforementioned advantages can be achieved in an optimized manner.

In an alternative embodiment, to determine the first coefficient and the second coefficient for the first and the second components of the at least one harmonic of the angle error signal, the product of the correction input angle signal and the first or second angular function of the first or second component of the at least one harmonic, using the frequency of the filter input angle signal, is added to the first and second coefficients of the previous time point at a predetermined time point in order to obtain the first and second coefficients. The predetermined time point and the previous time point are in particular separated by a time period corresponding to the sampling period of the position sensor. The method can thereby be carried out with low computational power, which can achieve the aforementioned advantages in a simple and efficient manner, in particular in older computing units with limited computational power.

In particular, by storing the last determined first and second coefficients at the end of a rotational movement after a restart of the angular measurement, harmonics can be compensated for in a reduced time as there is already a correction angle signal with which the measured angle signal can be corrected.

In one embodiment, the product of the correction input angle signal and the first angular function of the first component and the product of the correction input angle signal and the second angular function of the second component are further formed using an adjustment rate. By using the adjustment rate, also referred to as “learning rate,” the first and second coefficients may be more quickly adjusted to the angle error, thereby reducing computational effort and teach-in time to compensate for the angle error.

In one embodiment, the first and second coefficients are determined for at least two, three or four harmonics and the correction angle signal is determined by the sum of the correction angle signals for each of the harmonics. While improvements in the angle signal can already be achieved by compensating for a single harmonic, in particular the dominant harmonic, torque accuracy is further improved by compensating for multiple harmonics, in particular first to fourth order harmonics, because the corrected angle better represents the actual angle. As the first to fourth harmonics represent the most dominant oscillations of a system of position sensor and rotor, by compensating for these four harmonics, the best results can be achieved for the angle signal with a low computational effort.

In one embodiment, filtering of the filter input signal is performed by a state variable filter, which is in particular a low pass filter. A state variable filter with low-pass characteristics can be used to advantageously attenuate the harmonics in the angle signal at high rotational speeds.

By determining the frequency of the filter input angle signal in the state variable filter, periodic oscillations or harmonics in the frequency of the angle signal at high speeds can be compensated for, thereby improving the accuracy of the correction and allowing the method to be performed in an optimized manner.

In a further embodiment, to determine the first coefficient and the second coefficient for a first and a second component of the at least one harmonic of the angle error signal, the angular function of a component of the at least one harmonic is determined using the frequency of the filter input angle signal and a phase. The phase layer of the angle error signal and thus the phase position of the individual harmonics is determined, in particular by the state variable filter, based on its transfer function. To determine the phase position of the angle error accurately, the phase response of the angle error is determined using the transfer function of the state variable filter F_{S,φ}(s):

$${φ}_{E r r o r} = {φ}_{FiltInp} = 1 - FS , {}_{φ} ( s ) = s 3 / ( {s}^{3} + {c}_{2} {s}^{2} + {c}_{1} s + {c}_{0} ) ,$$

$${φ}_{F e h l e r} = {φ}_{F i l t E i n} = 1 - {F}_{S , φ} ( s ) = \frac{{s}^{3}}{{s}^{3} + {c}_{2} {s}^{2} + {c}_{1} s + {c}_{0}} ,$$

with the filter input angle signal φ_{FiltInp}, correction input angle signal φ_{CorrInp}, and angle error signal φ_{Error}. The transfer function F_{S,φ}(s) of the state variable filter must be considered, which has the following form:

$${F}_{S , φ} ( s ) = ( {c}_{2} {s}^{2} + {c}_{1} {s}^{1} + {c}_{0} ) / ( {s}^{3} + {c}_{2} {s}^{2} + {c}_{1} {s}^{1} + {c}_{0} )$$

$${F}_{S , φ} ( s ) = \frac{{c}_{2} {s}^{2} + {c}_{1} {s}^{1} + {c}_{0}}{{s}^{3} + {c}_{2} {s}^{2} + {c}_{1} {s}^{1} + {c}_{0}}$$

The variables c₀, c₁ and c₂ are filter coefficients, which serve to determine the frequency at which the vibrations are to be attenuated and s is the Laplace operator, which transforms the transfer function into the Laplace range.

By using the phase of the angle error signal, the determination of the correction angle signal may be further improved, thereby increasing the angular accuracy and torque accuracy, resulting in improved control of the electric machine.

A computing unit according to the invention, e.g., a control device of a motor vehicle, is configured, in particular in terms of programming, to carry out a method according to the invention.

The implementation of a method according to the invention in the form of a computer program or computer program product comprising program code for carrying out all method steps is advantageous as well, because the associated costs are very low, in particular if an executing control device is also used for other tasks and is therefore already available. Lastly, a machine-readable storage medium is provided, on which a computer program as described above is stored. Suitable storage media or data carriers for providing the computer program are in particular magnetic, optical and electrical memories, such as hard drives, flash memories, EEPROMs, DVDs, etc. Downloading a program via computer networks (Internet, intranet, etc.) is possible, too. Such a download can be wired or cabled or wireless (e.g., via a WLAN, a 3G, 4G, 5G, or 6G connection, etc.).

The invention is illustrated schematically in the drawing on the basis of an exemplary embodiment and is described in the following with reference to said drawing. Further advantages and embodiments of the invention will emerge from the description and the accompanying drawing.

### BRIEF DESCRIPTION OF THE DRAWINGS

FIG. 1 shows a block diagram of a computational unit as it may be based on the invention;

FIG. 2 shows a flowchart of one embodiment of the method.

### DETAILED DESCRIPTION

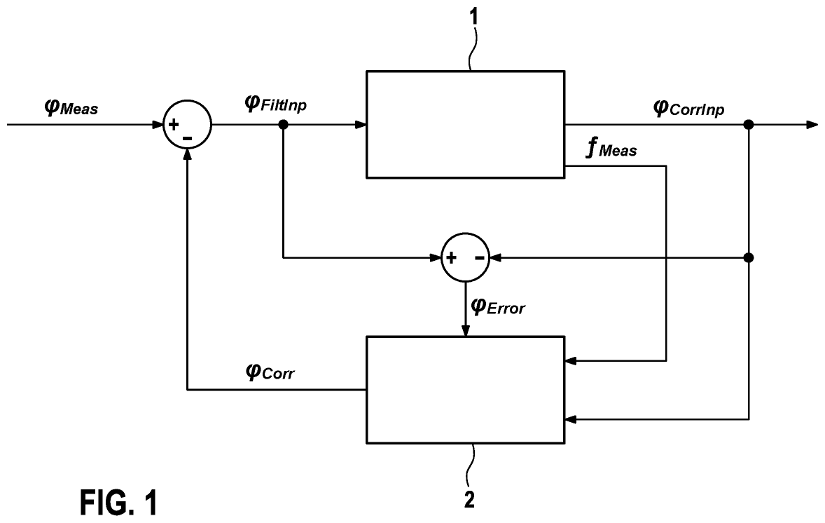

FIG. 1 shows a block diagram of a computational unit as it may be based on the invention. The computational unit comprises a state variable filter, ZVF, 1 and a correction module 2. The computational unit can be implemented in an evaluation unit of a rotary sensor or position sensor.

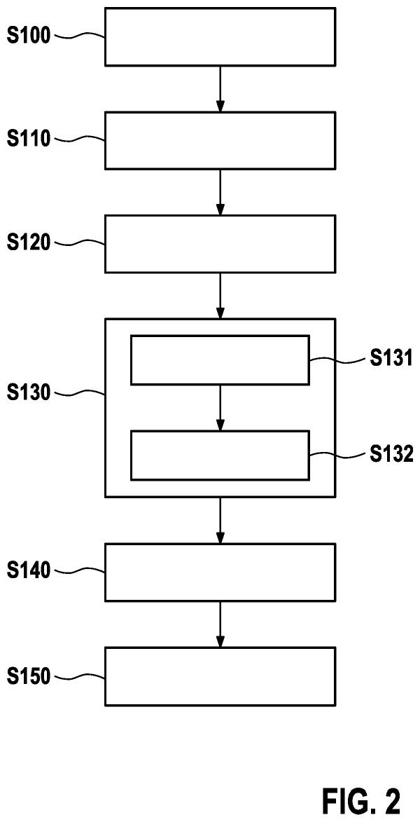

FIG. 2 shows a flow chart of one embodiment of the method, as it may be performed, for example, in the computational unit shown in FIG. 1. In particular, the method is performed again at each time point k, wherein successive time points (e.g., k and k+1) are separated by a sampling period Tₛ of the position sensor.

FIGS. 1 and 2 will now be described in a contiguous and comprehensive manner.

In a step S100, a rotational angle position is measured as a measured angle signal φ_{Meas} as a function of time. In particular, the angle signal φ_{Meas} can be measured by a position sensor (not shown), which is arranged on the rotor of an electric machine, for example. The position sensor may generate a sine and cosine signal, the angle being determinable according to a tan 2(sin/cos).

The measured angle signal φ_{Meas} is corrected in a step S110 with a correction angle signal φ_{Corr} in order to obtain a filter input angle signal φ_{FiltInp}, which is supplied to the state variable filter 1 as an input signal. The correction of the measured angle signal φ_{Meas} can in particular be performed by calculating a difference between the angle signal φ_{Meas} and the correction angle signal φ_{Corr}. The correction angle signal φ_{Corr} is output by the correction module 2.

In a next step S120, the filter input angle signal φ_{FiltInp} is filtered by the state variable filter 1 to obtain a correction input angle signal φ_{CorrInp}. The filtered signal corresponding to the correction input angle signal φ_{CorrInp} is output simultaneously as the rotational angle output signal, step S140.

The rotational angle output signal may then be further used, step S150, for example for controlling an electric machine as part of vector control, etc.

The state variable filter 1 is in particular a filter with a low pass behavior, through which harmonic components can be filtered out at increasing frequency or speed.

In particular, the state variable filter 1 also determines a frequency f_{Meas} of the filter input angle signal φ_{FiltInp} using the filter input angle signal φ_{FiltInp} and then outputs the frequency f_{Meas} and the correction input angle signal φ_{CorrInp} to the correction module 2.

In a block S130, in the correction module 2, the correction angle signal φ_{Corr} is determined as a function of the correction input angle signal φ_{CorrInp}, the frequency f_{Meas} of the filter input angle signal and the angle error signal φ_{Error} is determined as a difference between the correction angle input signal φ_{CorrInp} and the filter input angle signal φ_{FiltInp}.

The block S130 of determining the correction angle signal φ_{Corr} comprises a step S131 of determining a first coefficient and a second coefficient for a first and a second component of at least one harmonic of the angle error signal φ_{Error}. The components are shown below by angular functions, in particular sine and cosine functions.

To determine the first coefficient and the second coefficient, an algorithm may be used, on the one hand, which integrates a product of the correction input angle signal φ_{CorrInp} and an angular function of the first and second components of the harmonics, respectively, over a predetermined time period. In particular, the product may also include an adjustment rate gᵢ by which a faster adjustment of the first and second coefficients to the angle error is made. The argument of the angular function includes the frequency f_{Meas} of the filter input angle signal φ_{FiltInp} and a phase Φᵢ determined by the correction module 2 based on the transfer function of the state variable filter, wherein the time period is Tₛ, which may in particular correspond to the sampling rate of the position sensor.

Alternatively, it is also possible to determine the first and second coefficients for a selected time point k using an algorithm in which the first and second coefficients of the previous time point k−1 are added to the product of the correction input angle signal Φ_{CorrInp} and the angular function of the first and second components of the harmonic. The product can in particular contain the adjustment rate gᵢ. The argument of the angular function is composed of the frequency f_{Meas} of the filter input angle signal φ_{FiltInp} and the phase γi determined by the correction module 2 using the transmission function of the state variable filter, wherein the time k·Tₛ is selected as the time k·Ts, wherein Tₛ is the computing time (time difference between two sampling points, which can in particular correspond to the sampling rate k of the position sensor) and.

In a step S132, the correction angle signal φ_{Corr} is subsequently determined as a function of the determined first and second coefficients and a first angular functions of the first component and a second angular function of the second component of the at least one harmonic using the frequency f_{Meas} of the filter input angle signal φ_{FiltInp}. In other words, the correction angle signal φ_{Corr} is composed of a number of harmonics.

Step S130 and the associated steps S131 and S132, in which the correction angle signal φ_{Corr} is determined, are to be explained in more detail in the following using equations. The index “i” refers to the order of the observed harmonic, and magnitudes having such an index may take on different values depending on the observed harmonic order. The angle signals are time dependent angle signals, even if not indicated separately.

The angle error signal φ_{Error} may be represented by a sum of an angular function of a first and second component, each multiplied by an amplitude of the error. The components are hereinafter exemplified as sinus and cosine components, but may also be represented by real and imaginary components. To determine the overall error, harmonics are summed over N. The parameterized representation of the angle error signal φ_{Error} can be indicated by the following equation:

$${φ}_{E r r o r} = {\sum }_{i = 1}^{N} {a}_{i} cos ( {ω}_{i} \cdot t ) + {b}_{i} sin ( {ω}_{i} \cdot t ) \qquad ( 1 )$$

aᵢ is the amplitude of the cosine component and bᵢ is the amplitude of the sine component of the ith harmonic. The angular frequency γᵢ is given by:

$${ω}_{i} = i \cdot 2 π {f}_{M e a s} \qquad ( 2 )$$

The angular frequency ωᵢ of the angular functions is thus a multiple, depending on the order i of the harmonic, of the frequency determined by the state variable filter 1, f_{Meas} of the filter input angle signal φ_{FiltInp}.

The correction input angle signal ω_{CorrInp} can further be represented as follows:

$${φ}_{CorrInp} = {F}_{S , φ} ( s ) [ {\underbrace{{φ}_{FiltInp} ( s ) + {φ}_{Error} ( s )}}_{{φ}_{Meas}} - {φ}_{Corr} ( s ) ] \qquad ( 3 )$$

In this case, φ_{Error} is the angle error signal, in particular in a parameterized representation, F_{S,φ}(s) is the transfer function of the state variable filter 1 and φ_{CorrInp} the correction input angle signal output from the state variable filter 1.

The relationship between the angle error signal Error, the filter input angle signal φ_{FiltInp}, and the correction input angle signal φ_{CorrInp} can be represented as follows:

$${φ}_{E r r o r} = {φ}_{FiltInp} - {φ}_{C orrInp} = 1 - {F}_{S , φ} ( s ) = \frac{{s}^{3}}{{s}^{3} + {c}_{2} {s}^{2} + {c}_{1} s + {c}_{0}} \qquad ( 4 )$$

This can in particular also be used to determine the phase Φᵢ of the transfer function, which can further be used in determining the coefficients. The phase Φᵢ can be determined by the following equation:

$${Φ}_{i} = arg ( {φ}_{E r r o r} ) = arctan ( \frac{Im ( {φ}_{E r r o r} )}{Re ( {φ}_{E r r o r} )} ) = arctan ( \frac{{c}_{2} {ω}_{i}^{2} - {c}_{0}}{{ω}_{i} ( {ω}_{i}^{2} - {c}_{1} )} ) \qquad ( 5 )$$

with the angular frequency ωᵢ.

To compensate for the periodic angle errors, the correction angle signal φ_{Corr} must correspond to the angle error signal φ_{Error}.

$${φ}_{E r r o r} \hat{=} {φ}_{C o r r} = {\sum }_{i = 1}^{N} {\hat{a}}_{i} cos ( {ω}_{i} \cdot t ) + {\hat{b}}_{i} sin ( {ω}_{i} \cdot t ) \qquad ( 6 )$$

This results in the coefficients âᵢ and \hat{b}ᵢ having to correspond to the coefficients aᵢ and bᵢ of the angle error signal φ_{Error} in parameterized representation to compensate for the angle error.

This can be achieved by the following updating algorithm:

$$\frac{d}{d t} {\hat{a}}_{i} = {g}_{i} \cdot {φ}_{C orrInp} \cdot cos ( {ω}_{i} t + {Φ}_{i} ) \qquad ( 7 )$$

$$\frac{d}{d t} {\hat{b}}_{i} = {g}_{i} \cdot {φ}_{C orrInp} \cdot sin ( {ω}_{i} t + {Φ}_{i} ) \qquad ( 8 )$$

In this case, gᵢ is the adjustment rate, and Φᵢ is the phase of the transfer function. By integrating these equations over a predetermined period of time Tₛ, which may correspond in particular to the sampling rate of the position sensor, the first coefficient âᵢ and the second coefficient \hat{b}ᵢ can be determined.

Alternatively, at discrete time intervals, the updating algorithm may be implemented as follows:

$${\hat{a}}_{i} ( {kT}_{S} ) = {\hat{a}}_{i} [ ( k - 1 ) {T}_{S} ] + {g}_{i} {φ}_{C orrInp} ( k {T}_{S} ) cos ( {ω}_{i} k {T}_{S} + {Φ}_{i} ) \qquad ( 9 )$$

$${\hat{b}}_{i} ( k {T}_{S} ) = {\hat{b}}_{i} [ ( k - 1 ) {T}_{S} ] + {g}_{i} {φ}_{C orrInp} ( k {T}_{S} ) sin ( {ω}_{i} k {T}_{S} + {Φ}_{i} ) \qquad ( 10 )$$

Tₛ is a predetermined period of time, which can in particular correspond to the sampling rate of the position sensor. The first and second coefficients âᵢ, \hat{b}ᵢ in the implementation of the algorithm are determined in this by the coefficients of the previous time point k−1 being added to the product of adjustment rate, correction input angle signal in the selected time point k and angular function of the component of the harmonic at the selected time point k. The time points are thus different around the time period Tₛ. This procedure corresponds to a discrete integration using the Euler method, in particular the Euler method applied backward. The method can therefore be performed with less computational power and can therefore also be implemented in older systems.

The correction angle signal can be reproduced by means of the determined coefficients and angular functions of the components of the harmonic as follows:

$${φ}_{C o r r} = {\sum }_{i = 1}^{N} cos ( {ω}_{i} \cdot t + {Φ}_{i} ) + {\hat{b}}_{i} ( t ) sin ( {ω}_{i} \cdot t + {Φ}_{i} ) \qquad ( 11 )$$

This compensates for periodic angle errors, which in particular correspond to the vibrations of one or more harmonics, for example, whereby an electrical angle of an electric machine can be determined more precisely. As the electrical angle is necessary to determine the torque of an electric machine, the determination of the torque may be improved and thus the efficiency of the electric machine may be increased.

Furthermore, the method is not bound to a particular type of position sensor or design of the system and can therefore be used in older systems, but also future systems.

In test bench measurements where an electric machine was driven using the angle determined by the method according to the invention, the selected harmonics could be compensated very well, the method being tested across the entire speed range of the electric machine.

1. A method for determining a rotational angle output signal of a position sensor, comprising:
measuring (S100) a rotational angle position as a function of time as a measured angle signal (φ_{Meas}),
correcting (S110) the measured angle signal (φ_{Meas}) with a correction angle signal (φ_{Corr}) in order to obtain a filter input angle signal (φ_{FiltInp});
filtering (S120) the filter input angle signal (φ_{FiltInp}) in order to obtain a correction input angle signal (φ_{CorrInp});
determining (S130) the correction angle signal (φ_{Corr}) as a function of the correction input angle signal (φ_{CorrInp}), a frequency (f_{Meas}) of the filter input angle signal (φ_{FiltInp}), and an angle error signal (φ_{Error}), wherein the angle error signal (φ_{Error}) is determined by calculating a difference between the filter input angle signal (φ_{FiltInp}) and the correction input angle signal (φ_{CorrInp}), and
outputting (S140) the correction input angle signal (φ_{CorrInp}) as the rotational angle output signal,
wherein determining (S130) the correction angle signal (φ_{Corr}) comprises:
determining (S131) a first coefficient and a second coefficient for a first and a second component of at least one harmonic of the angle error signal (φ_{Error}), and
determining (S132) the correction angle signal (φ_{Corr}) as a function of the determined first and second coefficients, a first angular function of the first component, and a second angular function of the second component of the at least one harmonic using the frequency (f_{Meas}) of the filter input angle signal (φ_{FiltInp}).

2. The method according to claim 1, wherein determining (S131) the first coefficient and the second coefficient for the first and the second components of at least one harmonic of the angle error signal (φ_{Error}) comprises: integrating a product of the correction input angle signal (φ_{CorrInp}) and the first angular function of the first component of the at least one harmonic, using the frequency (f_{Meas}) of the filter input angle signal (φ_{FiltInp}) over a predetermined time period in order to obtain the first coefficient, and
integrating a product of the correction input angle signal (φ_{CorrInp}) and the second angular function of the second component of the at least one harmonic, using the frequency (f_{Meas}) of the filter input angle signal (φ_{FiltInp}), over the predetermined time period in order to obtain the second coefficient.

3. The method according to claim 1, wherein determining (S131) the first coefficient and the second coefficient for the first and the second components of at least one harmonic of the angle error signal (φ_{Error}) comprises:
adding a product of the correction input angle signal (φ_{CorrInp}) and the first angular function of the first component of the at least one harmonic using the frequency (f_{Meas}) of the filter input angle signal (φ_{FiltInp}), at a predetermined time point with the first coefficient of a previous time point in order to obtain the first coefficient, and
adding a product of the correction input angle signal (φ_{CorrInp}) and the first angular function of the first component of the at least one harmonic, using the frequency (f_{Meas}) filter input angle signal (φ_{FiltInp}), at the predetermined time point with the first coefficient of the previous time point in order to obtain the first coefficient.

4. The method according to claim 2, wherein the product of the correction input angle signal (φ_{CorrInp}) and the first angular function of the first component and the product of the correction input angle signal (φ_{CorrInp}) and the second angular function of the second component are further calculated using an adjustment rate (gᵢ).

5. The method according to claim 1, wherein the first and second coefficients are determined for at least two, preferably three, more preferably four, harmonics, and the correction angle signal (φ_{Corr}) is a sum of the correction angle signals for each of the harmonics.

6. The method according to claim 1, wherein filtering (S120) is performed by a state variable filter (1), wherein the state variable filter (1) comprises a low-pass filter.

7. The method according to claim 6, wherein to determine (S131) the first coefficient and the second coefficient for the first and the second component of at least one harmonic of the angle error signal (φ_{Error}), the angular function of each component of the at least one harmonic is determined using the frequency (f_{Meas}) of the filter input angle signal (φ_{FiltInp}) and a phase of the angle error signal (φ_{Error}).

8. The method according to claim 7, wherein the phase of the angle error signal (φ_{Error}) is determined using a transfer function of the state variable filter (1).

9. The method according to claim 8, wherein the transfer function of the angle error is given by an equation:
$${φ}_{FiltInp} - {φ}_{CorrInp} = 1 - {F}_{S , φ} ( s ) = \frac{{s}^{3}}{{s}^{3} + {c}_{2} {s}^{2} + {c}_{1} s + {c}_{0}} ,$$
with a transmission function F_{S,φ}(s), the filter input angle signal φ_{FiltInp}, the correction input angle signal φ_{CorrInp}, the filter coefficients c₀, c₁ and c₂ and a Laplace operator s.

10. The method according to claim 1, wherein correcting (S110) the measured angle input signal (φ_{Meas}) comprises calculating a difference between the measured angle input signal (φ_{Meas}) and the determined correction angle signal (φ_{Corr}).

11. The method according to claim 1, further comprising using (S150) the rotational angle output signal to drive an electric machine.

12. A computing unit configured to perform all method steps of a method according to claim 1.

13. A non-transitory, computer-readable medium containing instructions that, when executed on a computer, cause the computer to determine a rotational angle output signal of a position sensor, by:
measuring (S100) a rotational angle position as a function of time as a measured angle signal (φ_{Meas}),
correcting (S110) the measured angle signal (φ_{Meas}) with a correction angle signal (φ_{Corr}) in order to obtain a filter input angle signal (φ_{FiltInp});
filtering (S120) the filter input angle signal (φ_{FiltInp}) in order to obtain a correction input angle signal (φ_{CorrInp});
determining (S130) the correction angle signal (φ_{Corr}) as a function of the correction input angle signal (φ_{CorrInp}), a frequency (f_{Meas}) of the filter input angle signal (φ_{FiltInp}), and an angle error signal (φ_{Error}), wherein the angle error signal (φ_{Error}) is determined by calculating a difference between the filter input angle signal (φ_{FiltInp}) and the correction input angle signal (φ_{CorrInp}), and
outputting (S140) the correction input angle signal (φ_{CorrInp}) as the rotational angle output signal,
wherein determining (S130) the correction angle signal (φ_{Corr}) comprises:
determining (S131) a first coefficient and a second coefficient for a first and a second component of at least one harmonic of the angle error signal (φ_{Error}), and
determining (S132) the correction angle signal (φ_{Corr}) as a function of the determined first and second coefficients, a first angular function of the first component, and a second angular function of the second component of the at least one harmonic using the frequency (f_{Meas}) of the filter input angle signal (φ_{FiltInp}).

14. (canceled)
